(19) United States
(12) Patent Application Publication
(10) Pub. No.: US 2018/0026923 A1
(43) Pub. Date: Jan. 25, 2018

(54) ELECTRONIC DEVICE AND EMAIL MANAGEMENT METHOD THEREFOR

(71) Applicant: SAMSUNG ELECTRONICS CO., LTD., Suwon-si (KR)

(72) Inventors: Jeongsik CHO, Suwon-si (KR); Kyunghwan KIM, Suwon-si (KR)

(21) Appl. No.: 15/483,176

(22) Filed: Apr. 10, 2017

(30) Foreign Application Priority Data
Jul. 20, 2016 (KR) 10-2016-0092186

(51) Int. Cl. H04L 12/58; G06F 3/0484; H04L 29/08

(52) U.S. Cl. CPC H04L 51/046; H04L 51/18; H04L 51/34; H04L 51/26; H04L 67/02; G06F 3/04842

(57) ABSTRACT

An email management method for an electronic device is provided. The method may include: receiving an email message comprising a message body and a reply deadline; displaying a task logging UI element including a URL for recording the reply deadline as a task; and recording, when the task logging UI element is selected, the reply deadline for the email message as a task managed by a schedule management application.

### CROSS-REFERENCE TO RELATED APPLICATION

This application is based on and claims priority under 35 U.S.C. §119 to Korean Patent Application No. 10-2016-0092186 filed on Jul. 20, 2016 which is hereby incorporated by reference herein in its entirety.

### TECHNICAL FIELD

The present disclosure relates generally to an electronic device and a method of email management therefor. For example, the present disclosure relates to an electronic device and a method for managing reply messages.

### BACKGROUND

Electronic mail (email) is a service enabling electronic devices of a sender and a recipient to exchange messages through a network.

When the electronic device of a sender transmits an email message to the electronic device of a specific recipient, the recipient may read the body of the email message using an email application.

In this case, when the sender sets a reply request option, the electronic device may send an email message with a reply request flag set to a given value. Then, when the recipient views the email message using an email application, a popup window requesting a reply may be displayed together with the message body.

Such a popup window may contain, for example, notification words “a reply is required for this message”.

If the email application of the recipient is unable to properly handle the reply request flag of a received email message, a popup window requesting a reply may be not displayed when the recipient reads the received message.

Hence, the recipient having read a received email message requiring a reply may fail to make a reply to the received message. In addition, although a popup window requesting a reply is displayed, when a follow-up measure for managing a reply message is not taken, the recipient may fail to make a suitable reply to a received message.

### SUMMARY

Aspects of the present disclosure address at least the above mentioned problems and/or disadvantages and to provide at least the advantages described below. Accordingly, an example aspect of the present disclosure is to provide an electronic device and email management method therefor that enable the user to send a reply message without fail in response to an email message requiring a reply.

In accordance with an example aspect of the present disclosure, a method for email management in an electronic device is provided. The method may include: receiving an email message comprising a message body and a reply deadline; displaying a task logging user interface (UI) element including a uniform resource locator (URL) for recording the reply deadline as a task; and recording, when the task logging UI element is selected, the reply deadline for the email message as a task managed by a schedule management application.

In accordance with another example aspect of the present disclosure, an electronic device is provided. The electronic device may include: a display configured to output visual information; a communication unit comprising communication circuitry configured to communicate with an external electronic device; and a processor electrically connected with the display and communication unit. The processor may be configured to control the communication unit to receive an email message comprising a message body and a reply deadline from the external electronic device, to control the display to display a task logging UI element including a URL for recording the reply deadline as a task, and to record, when the task logging UI element is selected, the reply deadline for the email message as a task managed by a schedule management application.

In accordance with another example aspect of the present disclosure, a computer-readable storage medium storing a scheduling program is provided. When executed by an electronic device, the scheduling program may cause the electronic device to: receive an email message having a message body and a reply deadline; display a task logging UI element containing a URL for recording the reply deadline as a task; and record, when the task logging UI element is selected, the reply deadline for the email message as a task managed by a schedule management application.

### BRIEF DESCRIPTION OF THE DRAWINGS

The above and other aspects, features and attendant advantages of the present disclosure will be more readily appreciated and understood from the following detailed description, taken in conjunction with the accompanying drawings, in which like reference numerals refer to like elements, and wherein:

FIG. 1A is a diagram illustrating an example network environment including electronic devices according to various example embodiments of the present disclosure;

FIG. 1B is a block diagram illustrating an example electronic device according to various example embodiments of the present disclosure;

FIG. 1C is a block diagram illustrating an example program module according to various example embodiments of the present disclosure;

FIG. 1D is a block diagram illustrating an example electronic device according to various example embodiments of the present disclosure;

FIG. 2 is a diagram illustrating an example screen representation for managing email messages in an electronic device of the sender according to various example embodiments of the present disclosure;

FIGS. 3A, 3B, 4, 5A, 5B, 5C, 5D and 6 are diagrams illustrating example screen representations for managing email messages in an electronic device of the recipient according to various example embodiments of the present disclosure;

FIG. 7 is a flowchart illustrating an example procedure for managing email messages in the electronic device of the sender according to various example embodiments of the present disclosure; and

FIG. 8 is a flowchart illustrating an example procedure for managing email messages in the electronic device of the recipient according to various example embodiments of the present disclosure.

### DETAILED DESCRIPTION

The following description is made with reference to the accompanying drawings, and is provided to assist in a comprehensive understanding of various example embodiments of the present disclosure as defined by the claims and their equivalents. It includes various details to assist in that understanding but these are to be regarded merely as examples. Accordingly, those of ordinary skill in the art will recognize that various changes and modifications of the various example embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used to enable a clear and consistent understanding of the present disclosure. Accordingly, it should be apparent to those skilled in the art that the following description of various example embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The expressions, such as “include” and “may include” which may be used in the present disclosure denote the presence of the disclosed functions, operations, and elements and do not limit one or more additional functions, operations, and elements. In an example embodiment of the present disclosure, the terms, such as “include” and/or “have” may be construed to denote a certain characteristic, number, operation, element, component or a combination thereof, but may not be construed to exclude the existence of or a possibility of addition of one or more other characteristics, numbers, operations, elements, components or combinations thereof.

Furthermore, in the present disclosure, the expression “and/or” includes any and all combinations of the associated listed words. For example, the expression “A and/or B” may include A, may include B, or may include both A and B.

In an example embodiment of the present disclosure, expressions including ordinal numbers, such as “first” and “second,” and the like, may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them are user devices. For example, a first element could be termed a second element, and similarly, a second element could be also termed a first element without departing from the scope of the present disclosure.

In the case where a component is referred to as being “connected” or “accessed” to other component, it should be understood that not only the component is directly connected or accessed to the other component, but also there may exist another component between them. Meanwhile, in the case where a component is referred to as being “directly connected” or “directly accessed” to other component, it should be understood that there is no component therebetween. The terms used in the present disclosure are only used to describe various example embodiments of the present disclosure, and are not intended to limit the present disclosure. As used herein, the singular forms are intended to include the plural forms as well, unless the context clearly indicates otherwise. Singular forms are intended to include plural forms unless the context clearly indicates otherwise.

An electronic device according to the present disclosure may be a device including a communication function. For example, the device may correspond to a combination of at least one of a smartphone, a tablet personal computer (PC), a mobile phone, a video phone, an e-book reader, a desktop PC, a laptop PC, a netbook computer, a personal digital assistant (PDA), a portable multimedia player (PMP), a digital audio player, a mobile medical device, an electronic bracelet, an electronic necklace, an electronic accessory, a camera, a wearable device, an electronic clock, a wrist watch, home appliances (for example, an air-conditioner, vacuum, an oven, a microwave, a washing machine, an air cleaner, and the like), an artificial intelligence robot, a television (TV), a digital versatile disc (DVD) player, an audio device, various medical devices (for example, magnetic resonance angiography (MRA), magnetic resonance imaging (MRI), computed tomography (CT), a scanning machine, an ultrasonic wave device, and the like), a navigation device, a global positioning system (GPS) receiver, an event data recorder (EDR), a flight data recorder (FDR), a set-top box, a TV box (for example, Samsung HomeSync™, Apple TV™, or Google TV™), an electronic dictionary, vehicle infotainment device, an electronic equipment for a ship (for example, navigation equipment for a ship, gyrocompass, and the like), avionics, a security device, electronic clothes, an electronic key, a camcorder, game consoles, a head-mounted display (HMD), a flat panel display device, an electronic frame, an electronic album, furniture or a portion of a building/structure that includes a communication function, an electronic board, an electronic signature receiving device, a projector, or the like, but is not limited thereto. It will be apparent to those skilled in the art that the electronic device according to the present disclosure is not limited to the aforementioned devices.

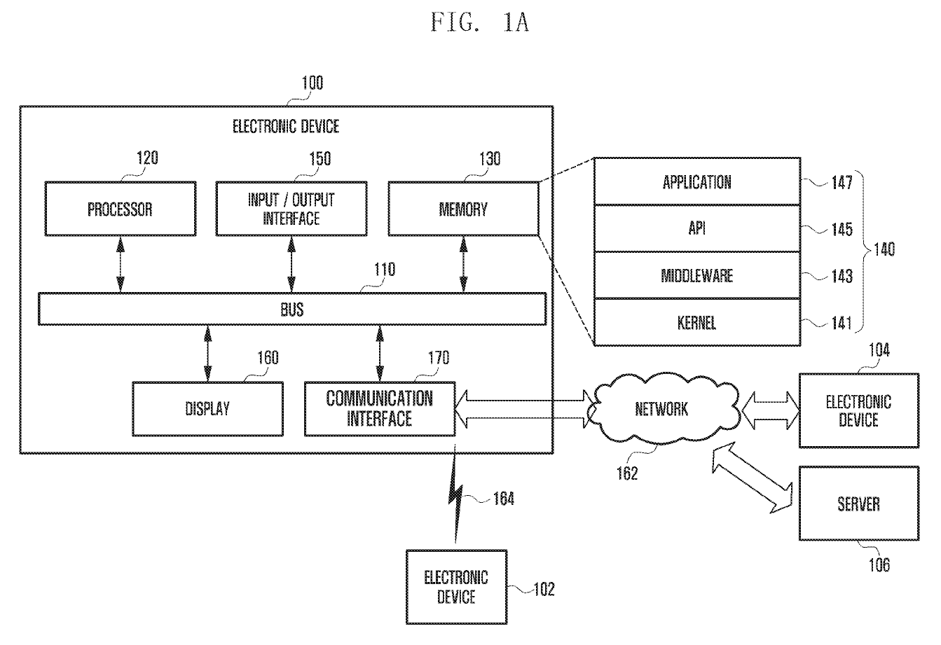

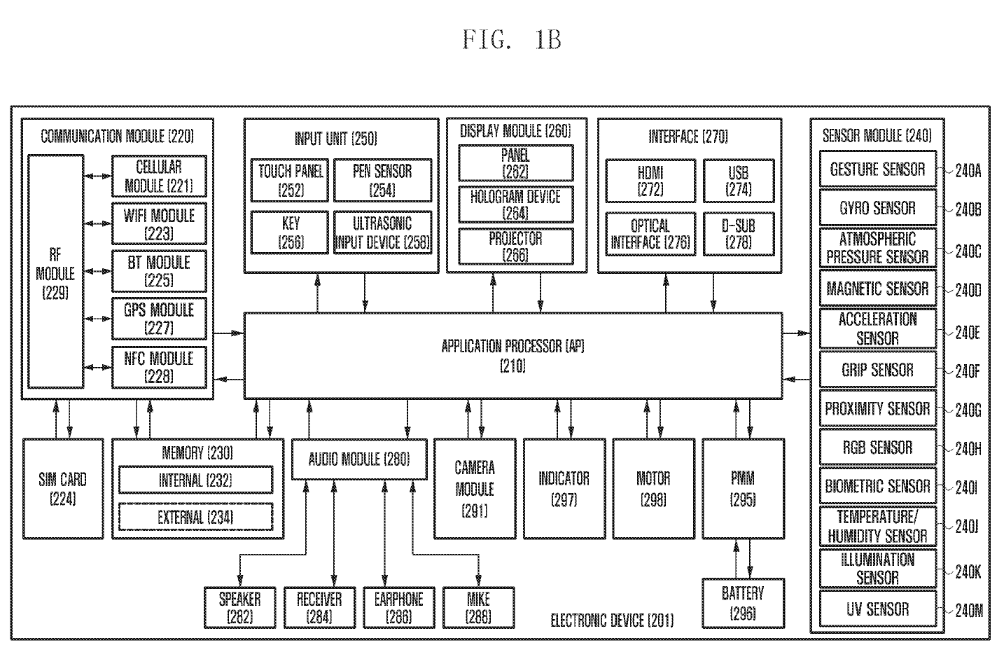

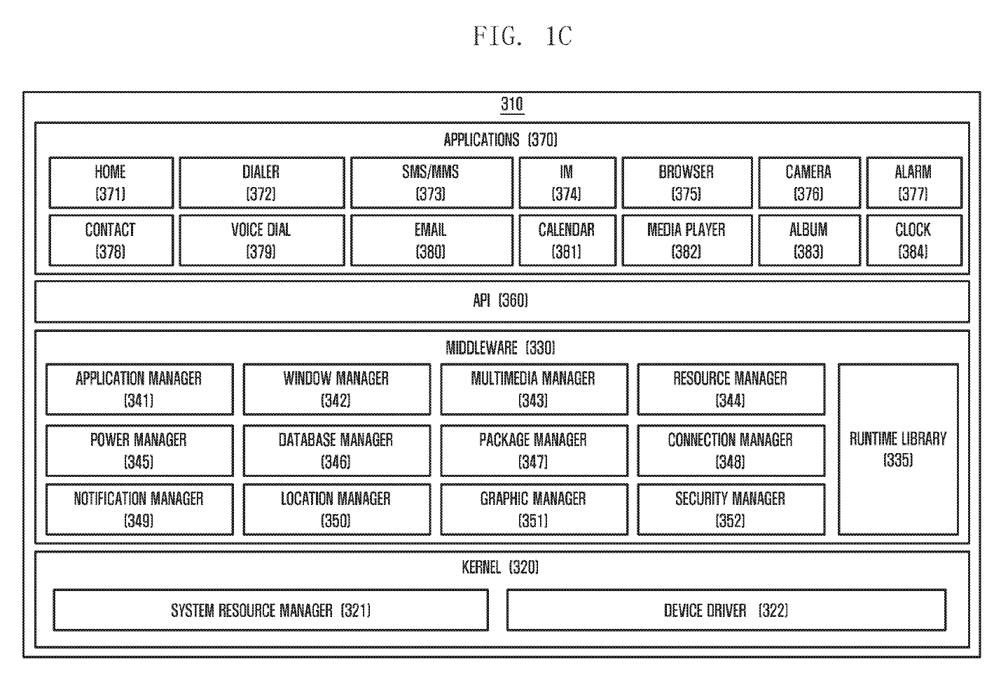

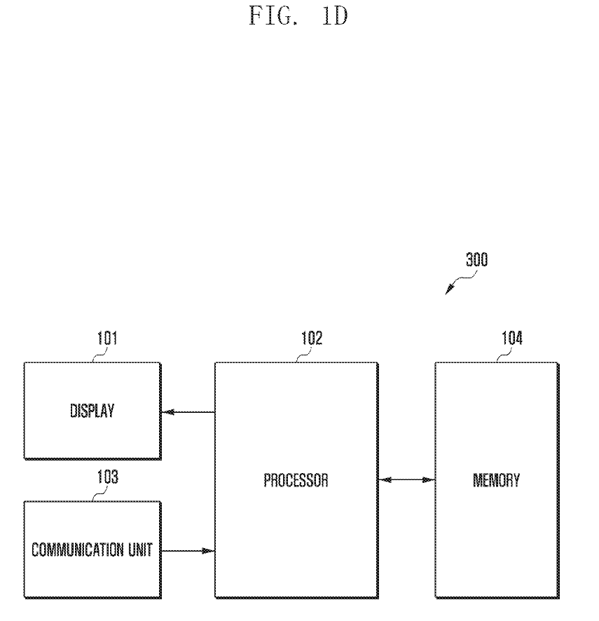

FIG. 1A is a block diagram illustrating an example configuration of an electronic device in a network environment according to an example embodiment of the present disclosure.

Referring to FIG. 1A, an electronic device 100 may include a bus 110, a processor (e.g., including processing circuitry) 120, a memory 130, an input/output (I/O) interface (e.g., including input/output circuitry) 150, a display 160, a communication interface (e.g., including communication circuitry) 170, and other similar and/or suitable components.

The bus 110 may be a circuit which interconnects the above-described elements and delivers a communication (e.g., a control message) between the above-described elements.

The processor 120 may include various processing circuitry and receive commands from the above-described other elements (e.g., the memory 130, the I/O interface 150, the display 160, the communication interface 170, and the like) through the bus 110, may interpret the received commands, and may execute calculation or data processing according to the interpreted commands.

The memory 130 may store commands or data received from the processor 120 or other elements (e.g., the I/O interface 150, the display 160, the communication interface 170, and the like) or generated by the processor 120 or the other elements. The memory 130 may include programming modules 140, including, for example, a kernel 141, middleware 143, an application programming interface (API) 145, an application 147, and the like. Each of the above-described programming modules may be implemented in software, firmware, hardware, or a combination of two or more thereof.

The kernel 141 may control or manage system resources (e.g., the bus 110, the processor 120, the memory 130, and the like) used to execute operations or functions implemented by other programming modules (e.g., the middleware 143, the API 145, and the application 147). In addition, the kernel 141 may provide an interface capable of accessing and controlling or managing the individual elements of the electronic device 100 by using the middleware 143, the API 145, or the application 147.

The middleware 143 may serve to go between the API 145 or the application 147 and the kernel 141 in such a manner that the API 145 or the application 147 communicates with the kernel 141 and exchanges data therewith. In addition, in relation to work requests received from one or more applications 140 and/or the middleware 143, for example, the middleware 143 may perform load balancing of the work requests by using a method of assigning a priority, in which system resources (e.g., the bus 110, the processor 120, the memory 130, and the like) of the electronic device 100 are allocated, to at least one of the one or more applications 140.

The API 145 is an interface through which the application 147 is capable of controlling a function provided by the kernel 141 or the middleware 143, and may include, for example, at least one interface or function for file control, window control, image processing, character control, and the like.

The I/O interface 150 may include various input/output circuitry and, for example, may receive a command or data as input from a user, and may deliver the received command or data to the processor 120 or the memory 130 through the bus 110. The display 160 may display a video, an image, data, and the like, to the user.

The communication interface 170 may include various communication circuitry and may connect communication between another electronic device 102 and the electronic device 100. The communication module 170 may support a short-range communication protocol 164 (e.g., Wi-Fi, Bluetooth (BT), and near field communication (NFC)), or a network 162 (e.g., the Internet, a local area network (LAN), a wide area network (WAN), a telecommunication network, a cellular network, a satellite network, a plain old telephone service (POTS), and the like). Each of the electronic devices 102 and 104 may be identical (e.g., of an identical type) to or different (e.g., of a different type) from the electronic device 100. Further, the communication module 170 may connect communication between a server 106 and the electronic device 100 via the network 162.

FIG. 1B is a block diagram illustrating an example configuration of an electronic device according to an example embodiment of the present disclosure.

Referring to FIG. 1B, an electronic device 201 may be, for example, the electronic device 100 illustrated in FIG. 1.

The electronic device 201 may include one or more processors (e.g., including processing circuitry) 210, a subscriber identification module (SIM) card 224, a memory 230, a communication module (e.g., including communication circuitry) 220, a sensor module 240, an input unit (e.g., including input circuitry) 250, a display module 260, an interface (e.g., including interface circuitry) 270, an audio module 280, a camera module 291, a power management module 295, a battery 296, an indicator 297, a motor 298 and any other similar and/or suitable components.

The processor 210 (e.g., the processor 120) may include various processing circuitry, such as, for example, and without limitation, one or more application processors (APs), or one or more communication processors (CPs). The processor 210 may be, for example, the processor 120 illustrated in FIG. 1. The AP and the CP are illustrated as being included in the processor 210 in FIG. 1B, but may be included in different integrated circuit (IC) packages, respectively. According to an embodiment of the present disclosure, the AP and the CP may be included in one IC package.

The AP may execute an operating system (OS) or an application program, and thereby may control multiple hardware or software elements connected to the AP and may perform processing of and arithmetic operations on various data including multimedia data. The AP may be implemented by, for example, a system on chip (SoC). According to an embodiment of the present disclosure, the processor 210 may further include a graphics processing unit (GPU) (not illustrated).

The CP may manage a data line and may convert a communication protocol in the case of communication between the electronic device (e.g., the electronic device 100) including the electronic device 201 and different electronic devices connected to the electronic device through the network. The CP may be implemented by, for example, an SoC. According to an example embodiment of the present disclosure, the CP may perform at least some of multimedia control functions. The CP, for example, may distinguish and authenticate a terminal in a communication network by using a SIM (e.g., the SIM card 224). In addition, the CP may provide the user with services, such as a voice telephony call, a video telephony call, a text message, packet data, and the like.

Further, the CP may control the transmission and reception of data by the communication module 220. In FIG. 1B, the elements, such as the CP, the power management module 295, the memory 230, and the like are illustrated as elements separate from the AP. However, according to an example embodiment of the present disclosure, the AP may include at least some (e.g., the CP) of the above-described elements.

According to an example embodiment of the present disclosure, the AP or the CP may load, to a volatile memory, a command or data received from at least one of a non-volatile memory and other elements connected to each of the AP and the CP, and may process the loaded command or data. In addition, the AP or the CP may store, in a non-volatile memory, data received from or generated by at least one of the other elements.

The SIM card 224 may be inserted into a slot formed in a particular portion of the electronic device 100. The SIM card 224 may include unique identification information (e.g., integrated circuit card identifier (ICCID)) or subscriber information (e.g., international mobile subscriber identity (IMSI)).

The memory 230 may include an internal memory 232 and/or an external memory 234. The memory 230 may be, for example, the memory 130 illustrated in FIG. 1. The internal memory 232 may include, for example, at least one of a volatile memory (e.g., a random access memory (RAM), a dynamic RAM (DRAM), a static RAM (SRAM), a synchronous dynamic RAM (SDRAM), and the like), and a non-volatile memory (e.g., a read only memory (ROM), a one time programmable ROM (OTPROM), a programmable ROM (PROM), an erasable and programmable ROM (EPROM), an electrically erasable and programmable ROM (EEPROM), a mask ROM, a flash ROM, a not AND (NAND) flash memory, a not OR (NOR) flash memory, and the like). According to an embodiment of the present disclosure, the internal memory 232 may be in the form of a solid state drive (SSD). The external memory 234 may further include a flash drive, for example, a compact flash (CF), a secure digital (SD), a micro-SD, a mini-SD, an extreme digital (xD), a memory stick, and the like.

The communication module 220 may include a communication module 220 including a radio frequency (RF) module 229. The communication module 220 may be, for example, the communication module 160 illustrated in FIG. 1A. The communication module 220 may include various communication circuitry, such as, for example, and without limitation, a Wi-Fi module 223, a BT module 225, a GPS module 227, and a NFC module 228. For example, the communication module 220 may provide a wireless communication function by using an RF. Additionally or alternatively, the communication module 220 may include a network interface (e.g., a LAN card), a modulator/demodulator (modem), and the like for connecting the electronic device 201 to a network (e.g., the Internet, a LAN, a WAN, a telecommunication network, a cellular network, a satellite network, a POTS, and the like).

The communication module 220 (e.g., the communication module 170) may perform data communication with other electronic devices (e.g., the electronic device 104 and the server 106) through a network. According to an example embodiment of the present disclosure, the communication module 220 may include various communication circuitry including, for example, and without limitation, a cellular module 221, a Wi-Fi module 223, a BT module 225, a GPS module 227, an NFC module 228, and an RF module 229.

The RF module 229 may be used for transmission and reception of data, for example, transmission and reception of RF signals or other electronic signals. Although not illustrated, the RF module 229 may include, for example, a transceiver, a power amplifier module (PAM), a frequency filter, a low noise amplifier (LNA), and the like. In addition, the RF module 229 may further include a component for transmitting and receiving electromagnetic waves in a free space in a wireless communication, for example, a conductor, a conductive wire, and the like.

The sensor module 240 may include various sensors, such as, for example, and without limitation, at least one of a gesture sensor 240A, a gyro sensor 240B, an atmospheric pressure sensor 240C, a magnetic sensor 240D, an acceleration sensor 240E, a grip sensor 240F, a proximity sensor 240G, a red, green and blue (RGB) sensor 240H, a biometric sensor 240I, a temperature/humidity sensor 240J, an illumination sensor 240K, and an ultra violet (UV) sensor 240M. The sensor module 240 may measure a physical quantity or may detect an operating state of the electronic device 201, and may convert the measured or detected information into an electrical signal. Additionally/alternatively, the sensor module 240 may include, for example, an Electronic nose (E-nose) sensor (not illustrated), an electromyography (EMG) sensor (not illustrated), an electroencephalogram (EEG) sensor (not illustrated), an electrocardiogram (ECG) sensor (not illustrated), a fingerprint sensor (not illustrated), and the like. The sensor module 240 may further include a control circuit (not illustrated) for controlling one or more sensors included therein.

The input unit 250 may include various input circuitry, such as, for example, and without limitation, a touch panel 252, a pen sensor 254 (e.g., a digital pen sensor), keys 256, and an ultrasonic input device 258. The input unit 250 may be, for example, the I/O module 150 illustrated in FIG. 1A. The touch panel 252 may recognize a touch input in at least one of, for example, a capacitive scheme, a resistive scheme, an infrared scheme, and an acoustic wave scheme. In addition, the touch panel 252 may further include a controller (not illustrated). In the capacitive type, the touch panel 252 is capable of recognizing proximity as well as a direct touch. The touch panel 252 may further include a tactile layer (not illustrated). In this event, the touch panel 252 may provide a tactile response to the user.

The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input device 258 enables the terminal to detect a sound wave by using a microphone (e.g., a microphone 288) of the terminal through a pen generating an ultrasonic signal, and to identify data. The ultrasonic input device 258 is capable of wireless recognition. According to an example embodiment of the present disclosure, the electronic device 201 may receive a user input from an external device (e.g., a network, a computer, or a server), which is connected to the communication module 220, through the communication module 220.

The display module 260 may include a panel 262, a hologram 264, and a projector 266. The display module 260 may be, for example, the display module 160 illustrated in FIG. 1A. The panel 262 may be, for example, a liquid crystal display (LCD) and an active matrix organic light emitting diode (AM-OLED) display, or the like, but is not limited thereto. The panel 262 may be implemented so as to be, for example, flexible, transparent, or wearable. The panel 262 may include the touch panel 252. The hologram 264 may display a three-dimensional image in the air by using interference of light. The projector 266 is configured to project images onto a surface. According to an embodiment of the present disclosure, the display module 260 may further include a control circuit for controlling the panel 262, the hologram 264, and the projectors 266.

The interface 270 may include various interface circuitry, such as, for example, and without limitation, a high-definition multimedia interface (HDMI) 272, a universal serial bus (USB) 274, an optical interface 276, and a d-subminiature (D-sub) 278. Additionally or alternatively, the interface 270 may include, for example, SD/multi-media card (MMC) (not illustrated) or infrared data association (IrDA) (not illustrated).

An audio module 280 may bidirectionally convert between a voice and an electrical signal. The audio module 280 may convert voice information, which is input to or output from the audio module 280, through, for example, a speaker 282, a receiver 284, an earphone 286, the microphone 288, and the like. The camera module 291 may capture an image and a moving image. According to an embodiment of the present disclosure, the camera module 291 may include one or more image sensors (e.g., a front lens or a back lens), an image signal processor (ISP) (not illustrated), and a flash LED (not illustrated).

The power management module 295 may manage power of the electronic device 201. Although not illustrated, the power management module 295 may include, for example, a power management IC (PMIC), a charger IC, or a battery fuel gauge.

The PMIC may be mounted to, for example, an IC or an SoC semiconductor. Charging methods may be classified into a wired charging method and a wireless charging method. The charger IC may charge a battery, and may prevent an overvoltage or an overcurrent from a charger to the battery. According to an embodiment of the present disclosure, the charger IC may include a charger IC for at least one of the wired charging method and the wireless charging method. Examples of the wireless charging method may include a magnetic resonance method, a magnetic induction method, an electromagnetic method, and the like. Additional circuits (e.g., a coil loop, a resonance circuit, a rectifier, and the like) for wireless charging may be added to perform the wireless charging.

The battery fuel gauge may measure, for example, a residual quantity of the battery 296, or a voltage, a current, and a temperature during the charging. The battery 296 may supply power by generating electricity, and may be, for example, a rechargeable battery.

The indicator 297 may indicate particular states of the electronic device 201 or a part (e.g., the AP) of the electronic device 201, for example, a booting state, a message state, a charging state and the like. The motor 298 may convert an electrical signal into a mechanical vibration. The processor 210 may control the sensor module 240.

Although not illustrated, the electronic device 201 may include a processing unit (e.g., a GPU) for supporting a mobile TV. The processing unit for supporting a mobile TV may process media data according to standards, such as, for example, digital multimedia broadcasting (DMB), digital video broadcasting (DVB), media flow, and the like. Each of the above-described elements of the electronic device 201 according to an embodiment of the present disclosure may include one or more components, and the name of the relevant element may change depending on the type of electronic device. The electronic device 201 according to an embodiment of the present disclosure may include at least one of the above-described elements. Some of the above-described elements may be omitted from the electronic device 201, or the electronic device 201 may further include additional elements. In addition, some of the elements of the electronic device 201 according to an embodiment of the present disclosure may be combined into one entity, which may perform functions identical to those of the relevant elements before the combination.

The term “module” used in the present disclosure may refer to, for example, a unit including one or more combinations of hardware, software, and/or firmware. The “module” may be interchangeable with a term, such as “unit,” “logic,” “logical block,” “component,” “circuit,” and the like. The “module” may be a minimum unit of a component formed as one body or a part thereof. The “module” may be a minimum unit for performing one or more functions or a part thereof. The “module” may be implemented mechanically or electronically. For example, the “module” according to an example embodiment of the present disclosure may include at least one of a dedicated processor, a CPU, an application-specific integrated circuit (ASIC) chip, a field-programmable gate array (FPGA), and a programmable-logic device for performing certain operations which have been known or are to be developed in the future.

FIG. 1C is a block diagram illustrating an example configuration of a programming module according to an example embodiment of the present disclosure.

Referring to FIG. 1C, a programming module 310 may be included (or stored) in the electronic device 100 (e.g., the memory 130) or may be included (or stored) in the electronic device 201 (e.g., the memory 230). At least a part of the programming module 310 may be implemented in software, firmware, hardware, or a combination of two or more thereof. The programming module 310 may be implemented in hardware (e.g., the electronic device 201), and may include an OS for controlling resources related to an electronic device and/or various applications (e.g., an application 370) that are executed in the OS. For example, the OS may be Android®, iOS®, Windows®, Symbian®, Tizen®, Bada®, and the like.

Referring to FIG. 1C, the programming module 310 may include a kernel 320, a middleware 330, an API 360, and/or one or more applications 370.

The kernel 320 (e.g., the kernel 141) may include a system resource manager 321 and/or a device driver 322. The system resource manager 321 may include, for example, a process manager (not illustrated), a memory manager (not illustrated), and a file system manager (not illustrated). The system resource manager 321 may perform the control, allocation, recovery, and the like of system resources. The device driver 322 may include, for example, a display driver (not illustrated), a camera driver (not illustrated), a BT driver (not illustrated), a shared memory driver (not illustrated), a USB driver (not illustrated), a keypad driver (not illustrated), a Wi-Fi driver (not illustrated), and/or an audio driver (not illustrated). In addition, according to an embodiment of the present disclosure, the device driver 312 may include an inter-process communication (IPC) driver (not illustrated).

The middleware 330 may include multiple modules previously implemented to provide a function used in common by the applications 370. In addition, the middleware 330 may provide a function to the applications 370 through the API 360 to enable the applications 370 to efficiently use limited system resources within the electronic device. For example, as illustrated in FIG. 1C, the middleware 330 (e.g., the middleware 143) may include at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, a security manager 352, and any other suitable and/or similar manager.

The runtime library 335 may include, for example, a library module used by a complier, to add a new function by using a programming language during the execution of the application 370. According to an embodiment of the present disclosure, the runtime library 335 may perform functions which are related to input and output, the management of a memory, an arithmetic function, and the like.

The application manager 341 may manage, for example, a life cycle of at least one of the applications 370. The window manager 342 may manage graphical user interface (GUI) resources used on the screen. The multimedia manager 343 may detect a format used to reproduce various media files and may encode or decode a media file through a coder/decoder (codec) appropriate for the relevant format. The resource manager 344 may manage resources, such as a source code, a memory, a storage space, and the like of at least one of the applications 370.

The power manager 345 may operate together with a basic input/output system (BIOS), may manage a battery or power, and may provide power information and the like used for an operation. The database manager 346 may manage a database to enable the generation, search and/or change of the database to be used by at least one of the applications 370. The package manager 347 may manage the installation and/or update of an application distributed in the form of a package file.

The connection manager 348 may manage a wireless connection, such as, for example, a Wi-Fi connection and a BT connection. The notification manager 349 may display or report, to the user, an event, such as an arrival message, an appointment, a proximity alarm, and the like in such a manner as not to disturb the user. The location manager 350 may manage location information of the electronic device. The graphic manager 351 may manage a graphical effect, which is to be provided to the user, and/or a user interface related to the graphical effect. The security manager 352 may provide various security functions used for system security, user authentication, and the like. According to an embodiment of the present disclosure, when the electronic device (e.g., the electronic device 100) includes a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs to provide differentiated functions. In addition, the middleware 330 may dynamically delete some of the existing elements, or may add new elements. Accordingly, the middleware 330 may omit some of the elements described in the various embodiments of the present disclosure, may further include other elements, or may replace some of the elements with other elements, each of which performs a similar function and has a different name.

The API 360 (e.g., the API 145) is a set of API programming functions, and may be provided with a different configuration according to an OS. In the case of Android® or iOS®, for example, one API set may be provided to each platform. In the case of Tizen®, for example, two or more API sets may be provided.

The applications 370 (e.g., the applications 147) may include, for example, a preloaded application and/or a third party application. The applications 370 (e.g., the applications 147) may include, for example, a home application 371, a dialer application 372, a short message service

(SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 310 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 230. At least a part of the programming module 310 may be implemented (e.g., executed) by, for example, the one or more processors 210. At least a part of the programming module 310 may include, for example, a module, a program, a routine, a set of instructions, and/or a process for performing one or more functions.

Names of the elements of the programming module (e.g., the programming module 310) according to an embodiment of the present disclosure may change depending on the type of OS. The programming module according to an embodiment of the present disclosure may include one or more of the above-described elements. Alternatively, some of the above-described elements may be omitted from the programming module. Alternatively, the programming module may further include additional elements. The operations performed by the programming module or other elements according to an embodiment of the present disclosure may be processed in a sequential method, a parallel method, a repetitive method, or a heuristic method. In addition, some of the operations may be omitted, or other operations may be added to the operations.

FIG. 1D is a block diagram illustrating an example electronic device 300 according to various example embodiments of the present disclosure.

The electronic device 300 of FIG. 1D may include some or all of the components of the electronic device 100 of FIG. 1A. The electronic device 300 of FIG. 1D may include some or all of the components of the electronic device 100 of FIG. 1A. The electronic device 300 of FIG. 1D may also include some or all of the components of the electronic device 200 of FIG. 1B.

Referring to FIG. 1D, the electronic device 300 may include a display 101, a processor (e.g., including processing circuitry) 102, a communication unit (e.g., including communication circuitry) 103, and a memory 104. FIG. 1D illustrates an example configuration for realizing example embodiments of the present disclosure, and other hardware or software components known in the art may be added to the electronic device 300.

The display 101 may provide a display area to present visual information. The display 101 may fully or partially include the display 160 of FIG. 1A. The display 101 may fully or partially include the display 260 of FIG. 1B.

The communication unit 103 may include various communication circuitry and communicate with an external device. The external device may be, for example, an external server (not shown) that stores email messages sent by a sender or an electronic device of the sender. Here, the communication unit 103 may communicate with the electronic device of the sender via a gateway, a relay, a base station, or a server.

The communication unit 103 may fully or partially include the communication interface 170 of FIG. 1A. The communication unit 103 may fully or partially include the communication module 220 of FIG. 1B.

The processor 102 may include various processing circuitry and is electrically connected with the display 101, communication unit 103 and memory 104, and may control the overall operation of the electronic device 300. The processor 102 may fully or partially include the processor 102 of FIG. 1A. The processor 102 may fully or partially include the application processor 210 of FIG. 1B.

In various example embodiments, the processor 102 may control the communication unit 103 to receive an email message with a reply deadline from an external device.

Upon reception of an email message with a reply deadline, to record the reply deadline as a schedule item (task or event), the processor 102 may control the display 101 to display a task logging UI element.

When the task logging UI element is selected, the processor 102 may record the reply deadline for the email message as a schedule item (task) managed by a schedule management application. For example, upon reception of an input signal selecting the task logging UI element from a user input unit (e.g. input/output interface 150 of FIG. 1A or input unit 250 of FIG. 1B), the processor 102 may enter the reply deadline for the email message as a schedule item into a schedule management application.

To record the reply deadline as a schedule item, the processor 102 may display a schedule management window containing a reply deadline field.

When the reminder time arrives, the processor 102 may control the display 101 to display a reminder window having an email composition UI element containing a URL for email reply.

When the email composition UI element is selected, the processor 102 may control the display 101 to display an email composition window to compose a reply message for the corresponding email message.

In an example embodiment, when the reply request flag of the received email message is set to a given value, the processor 102 may control the display 101 to display a popup window containing a task logging UI element.

In an example embodiment, the URL may include at least one of a string value for invoking a schedule management application and a reply deadline.

In an example embodiment, the schedule management application may be an application identical or similar to the email application displaying a task logging UI element.

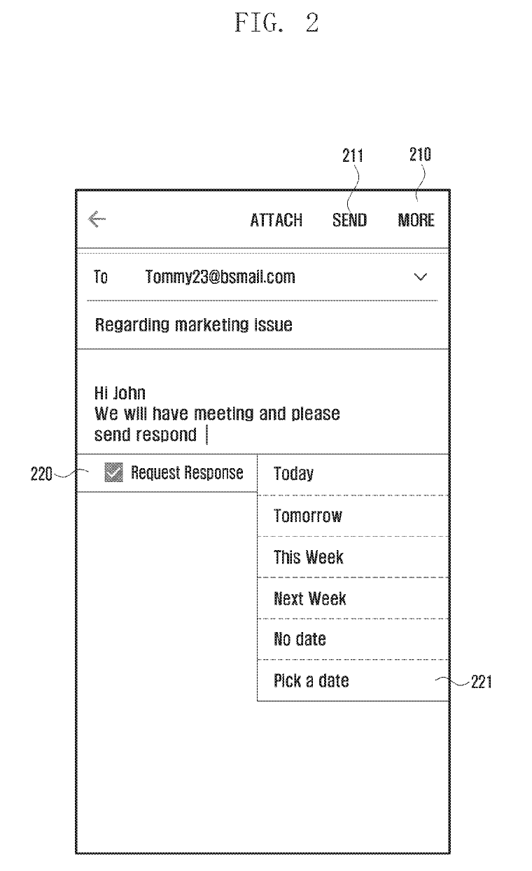

FIGS. 2, 3A, 3B, 4, 5A, 5B, 5C, 5D and 6 are diagrams illustrating example screen representations for managing email messages in the electronic device 300 according to various example embodiments of the present disclosure.

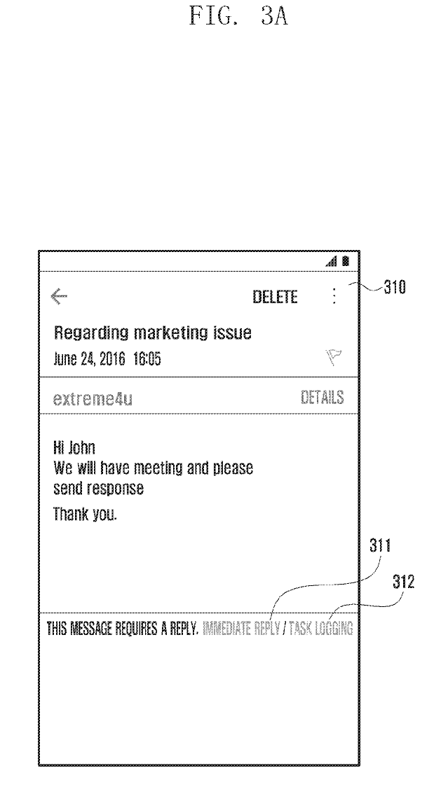

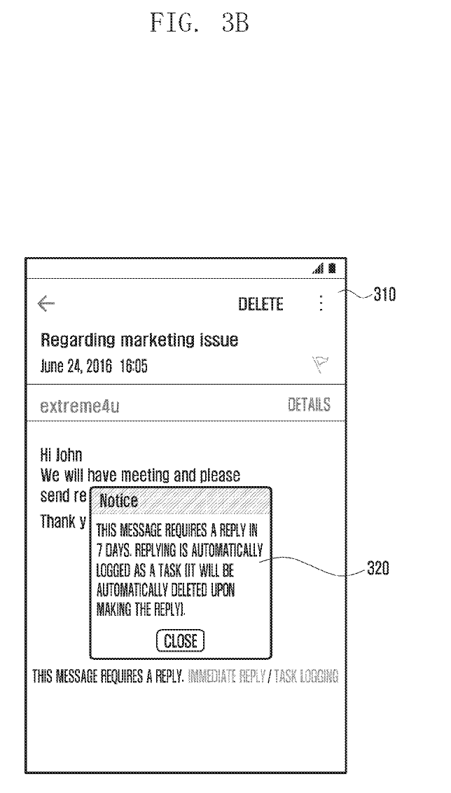

FIG. 2 is a diagram illustrating an example screen representation output by the electronic device 300 being used for sending an email message, and FIGS. 3A, 3B, 4, 5A, 5B, 5C, 5D and 6 are diagrams illustrating example screen representations output by the electronic device 300 being used for receiving an email message.

An email message may include at least one of a message body, a message title, and an attachment.

Referring to FIG. 2, the electronic device 300 of the sender may display an email composition window 210.

The email composition window 210 may include a reply deadline setting menu 220 to enable the sender to set a reply deadline for the email message.

The reply deadline setting menu 220 may be displayed together with the email composition window 210 for writing the message body as illustrated in FIG. 2, or may be displayed as a new popup window upon selection of “send” button 211 after the message body is written.

The user (sender) may use the reply deadline setting menu 220 to set a reply deadline for the email message. The reply deadline setting menu 220 may include time limit items, such as today, tomorrow, this week, next week, any date, and date choice. When one of the time limit items is selected by the user, a reply deadline may be set for the email message according to the selected time limit item. Here, when the date choice item 221 (“pick a date”) is selected, the electronic device 300 may additionally provide a window having an input field into which the user can directly enter a reply deadline.

Upon reception of a user input selecting the “send” button 211 after setting a reply deadline, the electronic device 300 may send the email message having the reply deadline to an electronic device of a designated recipient.

In an example embodiment, the electronic device 300 may automatically add a reply request flag set to a specific value to the email message to be sent so that a popup window requesting a reply may be displayed for the recipient. Here, the specific value may be ‘1’ or ‘0’.

Next, a description is given of receiving an email message. The electronic device 300 of the recipient may receive an email message having a message body and a reply deadline.

The reply deadline may be received as a separate message (e.g. as a reminder of a previous email message).

As illustrated in FIGS. 3A and 3B, the electronic device 300 of the recipient may display an email output window 310 to display the received email message and a notification of the reply deadline thereof.

The reply deadline notification for an email message may include words or phrases requesting a reply.

For example, as illustrated in FIG. 3A, the electronic device 300 may display reply-requesting words “This message requires a reply: Immediate reply/Task logging” under the message body. As another example, the electronic device 300 may display reply-requesting words indicating the reply deadline “This message requires a reply (in OO days): Immediate reply/Task logging”. As another example, the electronic device 300 may display reply-requesting words indicating the sender “This message (sent by AAA) requires a reply: Immediate reply? or Task logging?”.

When the email application of the electronic device 300 is capable of handling the reply request flag, the electronic device 300 may parse the reply request flag contained in the email message.

According to the parsing result, as illustrated in FIG. 3B, the electronic device 300 of the recipient may display a popup window 320 notifying a reply request for the email message.

The popup window 320 may contain reply-requesting words indicating the reply deadline. For example, the popup window 320 may contain words “This message requires a reply in 7 days. Replying is automatically logged as a task (it will be automatically deleted upon making the reply)”. In addition, the popup window 320 may include a task logging UI element containing a URL for recording the reply deadline as a schedule item (task).

When the task logging UI element is provided through the popup window 320, the task logging UI element may be not provided to the email message body.

A portion of the reply-requesting words may be associated with a UI element containing a URL. For example, the words “Immediate reply” may be associated with an email composition UI element 311 containing a URL for activating an email writing window to write a reply message for the received message.

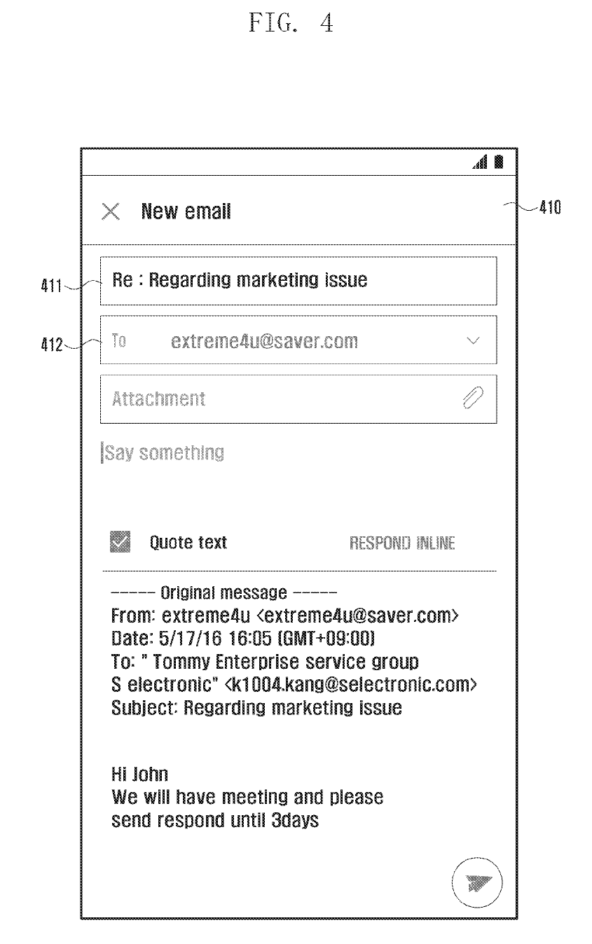

Upon reception of a user input selecting the words “Immediate reply” (e.g., email composition UI element 311), as illustrated in FIG. 4, the electronic device 300 may display an email writing window 410 for composing a reply message.

The email writing window 410 may include fields and sections for the message title, recipient, attachment, and message body. Here, the title field 411 may contain a prefix “Re:” to indicate a reply message, and the recipient field 412 may contain the email address of the sender of the received message in advance.

In addition, another portion of the reply-requesting words may be associated with a UI element containing a URL. For example, the words “Task logging” may be associated with a task logging UI element 312 to record the reply deadline of the received email message as a schedule item (task or event).

Upon reception of a user input selecting the words “Task logging” (e.g., task logging UI element 312), the electronic device 300 may enter the reply deadline set for the received email message as a schedule item into a schedule management application. Here, the schedule management application may be an application identical to the email application managing email messages.

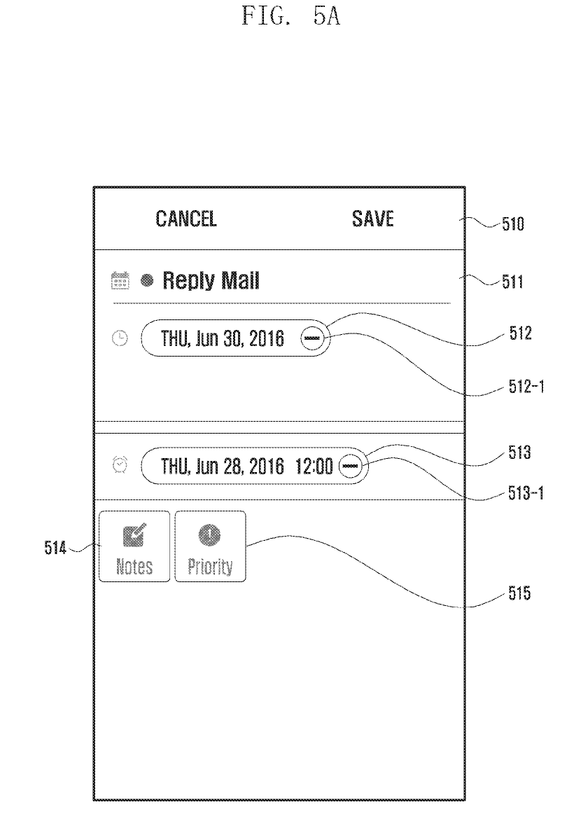

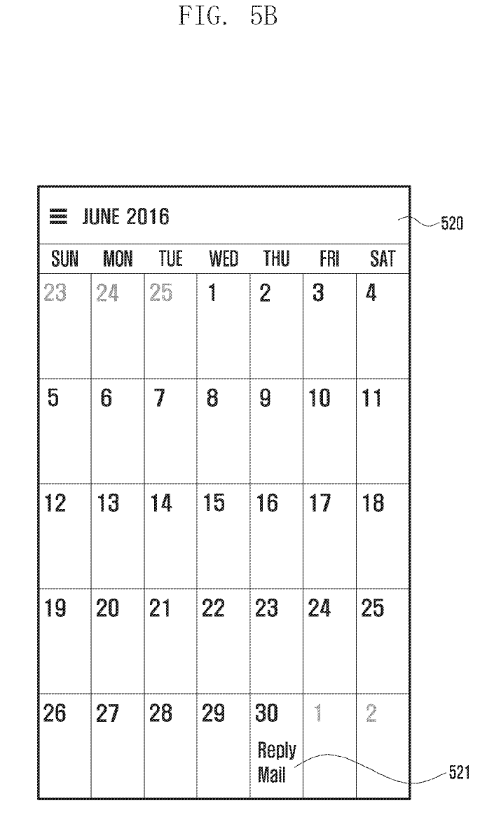

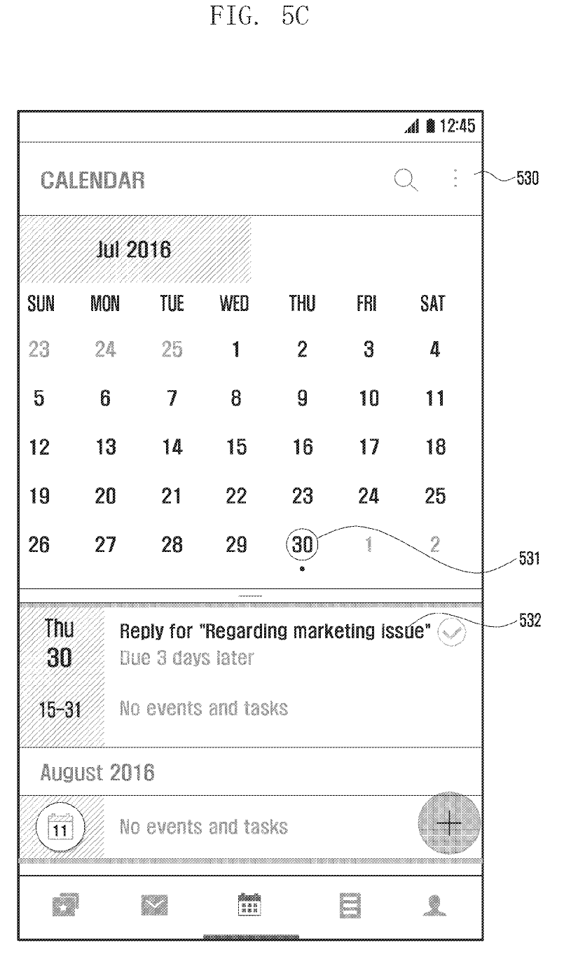

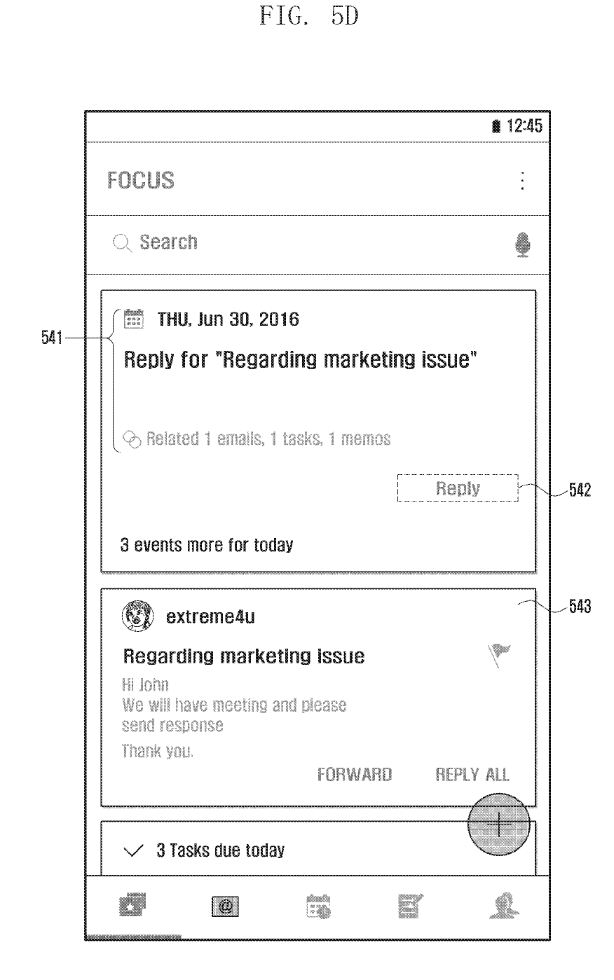

For example, upon reception of a user input selecting the words “Task logging” (e.g., task logging UI element 312), as illustrated in FIG. 5A, the electronic device 300 may display a schedule management window 510 to record the reply deadline of the received email message as a task.

For example, when the task logging UI element 312 is selected by the user, the electronic device 300 may parse the string contained in the task logging UI element 312 to identify the action and resource.

The URL contained in the task logging UI element 312 may have a string value referring to a schedule management application. For example, when the string value includes “calendar:”, the electronic device 300 may be aware that the URL contained in the task logging UI element 312 is of calendar type and display the schedule management window 510 by activating the schedule management application handling a calendar.

When the string value further includes a time limit value, the electronic device 300 may output the time limit value on the schedule management window 510.

The schedule management window 510 may include, for example, at least one of a title item 511 for reply message indication, a deadline item 512 for setting the reply deadline, a reminder item 513 for setting a reminder time for the reply deadline, a memo item 514 for writing a memo on the task, and a priority item 515 for assigning a priority to the task.

The title item 511 may present a preset title by default. For example, the default title may be “Reply Mail”, the title of the corresponding email message, the email address of the sender, or the name or nickname of the sender.

The deadline item 512 may present the reply deadline of the email message received by the electronic device 300 by default. Alternatively, the user may directly set the reply deadline using a date setting UI element 512-1.

The reminder item 513 may present a default reminder time that precedes the reply deadline by a preset time. The preset time may be one or two days, or may be varied according to the reply deadline. For example, the preset time may be adjusted in proportion to the remaining time to the reply deadline. Alternatively, the user may directly set the reminder time using a reminder setting UI element 513-1.

The memo item 514 may be used by the user to write a memo on the reply deadline or task.

The priority item 515 may be used by the user to assign a priority to the task or event. The priority may be used to resolve a scheduling conflict between tasks.

When the reply time for an email message is recorded as a task through the schedule management window 510, as illustrated in FIG. 5B, the recorded reply time may be displayed in the corresponding date cell 521 among multiple date cells of a calendar window 520.

The date cell 521 may present (at least partially) the title of email reply, the name or nickname of the sender, or the email address of the sender recorded in FIG. 5A. When the reply time and a different task fall on the same date cell 521, the order, color, font or size of the reply time may be changed based, for example, on the priority.

In another example embodiment, as illustrated in FIG. 5C, the recorded reply time may be displayed in the corresponding date cell 531 among multiple date cells of a calendar window 530, and details of the reply time may be displayed in a task display section 532. The task display section 532 may be used to present (at least partially) the title of email reply, the name or nickname of the sender, or the email address of the sender.

In various example embodiments, the recorded reply time may be used in conjunction with a schedule display application.

The schedule display application may be an application identical or similar to or different from the email application managing email messages.

When the task logging UI element 312 illustrated in FIG. 3A is selected, the reply time for the email message may be automatically recorded in the schedule management application as illustrated in FIG. 5D and an event card corresponding to the reply time may be generated.

The event card is provided by the schedule management application and may correspond to a memo on a schedule item recorded by the user or recorded automatically.

As illustrated in FIG. 5D, the schedule management application may produce at least one of a list of tasks or events occurring on a specific date, details of the tasks or events, and information regarding the tasks or events.

Referring to FIG. 5D, the schedule management application may output an event card display section 541 and a task handling function section 542.

The event card display section 541 may be used to present an event card corresponding to a specific task. In an example embodiment, the event card display section 541 may be used to present an event card corresponding to an email reply time. The event card may include information regarding at least one of an email reply time, a received email message related to the email reply time, a memo on the received email message, and a task related to the received email message.

The event card display section 541 may further include a section 542 to present at least one function corresponding to the email reply time. For example, the “reply” function may correspond to the email reply time. When the “reply” function is selected by the user, the electronic device 300 may output the email writing window 410 illustrated in FIG. 4 to enable the user to compose a reply message.

The task information display section 543 may be used to present information regarding the task corresponding to the event card. In one embodiment, the task information display section 543 may be used to present information regarding the email reply time. For example, the task information display section 543 may be used to output the received email message corresponding to the email reply time.

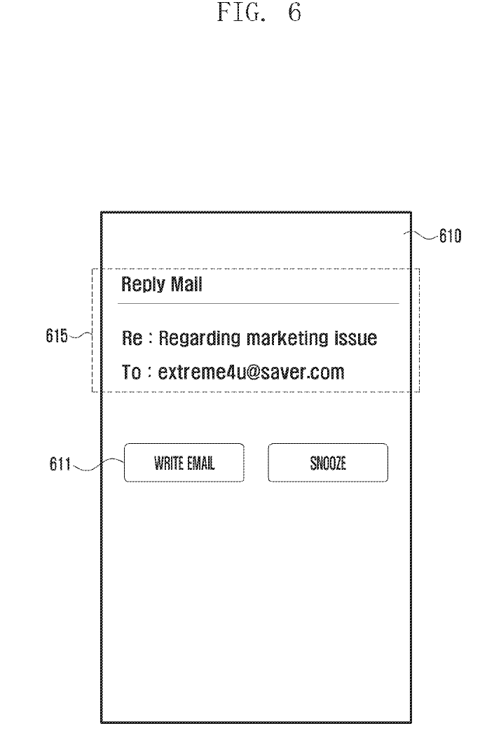

In addition, after recording the email reply time using the schedule management window 510, when the reminder time arrives, as illustrated in FIG. 6, the electronic device 300 may display a reminder window 610 to remind the user of email reply. The reminder window 610 may include an email composition UI element 611 having a URL for writing a reply message. The reminder window 610 may further include a header section 615 to present, for example, the title of the email message, the recipient thereof, at least a portion of the message body, and a reply deadline.

Upon reception of a user input selecting the email composition UI element 611, as illustrated in FIG. 4, the electronic device 300 may display an email writing window 410 for composing a reply message.

As described above, for an email message received from a sender, the recipient may send a reply message to the sender using the email management scheme of the electronic device.

Meanwhile, after sending an email message having a reply deadline to a recipient, if a reply message is not received within the reply deadline, the electronic device of the sender may automatically send a reminder email message to the recipient.

When a reply message is received within the reply deadline, the electronic device may notify the sender of reception of a reply message. Here, the electronic device of the sender may visually distinguish between a notification icon for a reply email message corresponding to a sent email message and a notification icon for a received email message without a preceding email message. For example, the electronic device may place a badge or mark on the notification icon for a reply email message, or may change the color, size, or shade of the notification icon for a reply email message so that it can be visually distinguished from the notification icon for reception of a regular email message.

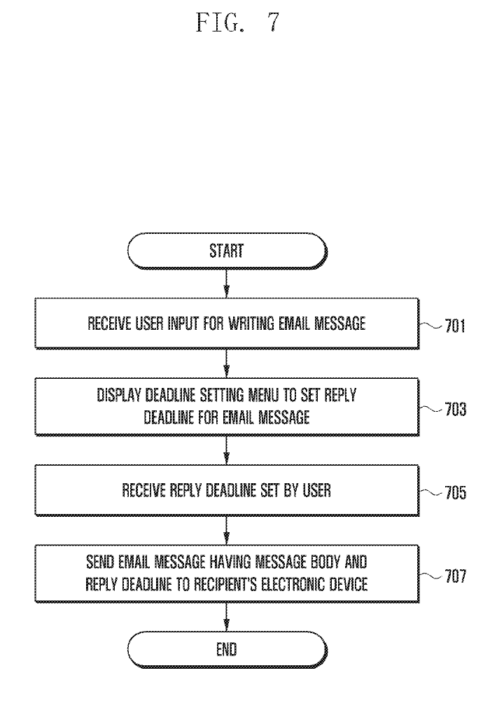

FIG. 7 is a flowchart illustrating an example procedure for managing email messages in the electronic device 300 of the sender according to an example embodiment of the present disclosure.

Referring to FIG. 7, at operation 701, the electronic device 300 receives an input, e.g., a user input for writing an email message.

At operation 703, the electronic device 300 displays a deadline setting menu to set a reply deadline for the email message. Operation 703 may be performed before operation 701.

At operation 705, the electronic device 300 receives a reply deadline set by the user using the deadline setting menu.

At operation 707, the electronic device 300 sends an email message having a message body and a reply deadline to an electronic device of a given recipient. In a certain situation, the message body and the reply deadline may be separately sent as different email messages.

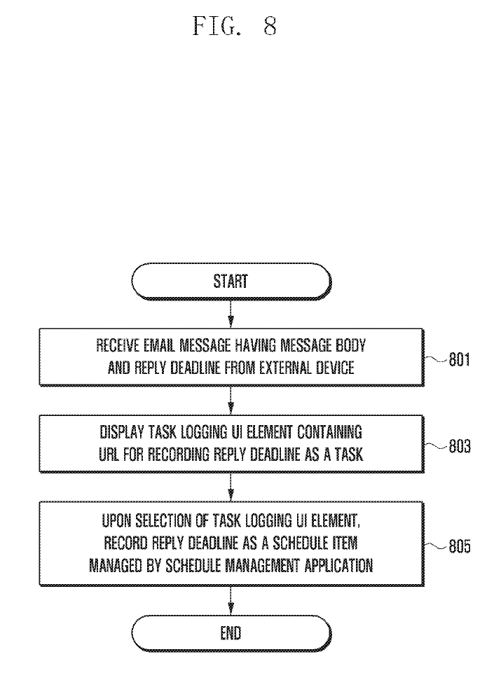

FIG. 8 is a flowchart illustrating an example procedure for managing email messages in the electronic device 300 of the recipient according to an example embodiment of the present disclosure.

Referring to FIG. 8, at operation 801, the electronic device 300 receives an email message having a message body and a reply deadline from an external device (e.g. electronic device of a sender or external server). The email message may be received from the sender via a gateway, a relay, a base station, or a server, or the like, but is not limited thereto.

Upon reception of an email message, at operation 803, the electronic device 300 displays a task logging UI element containing a URL for recording the reply deadline as a task or event.

In addition, the electronic device 300 may display an email composition UI element containing a URL for email reply. When the email composition UI element is selected, the electronic device 300 may display an email composition window to compose a reply message for the corresponding email message.

The URL may contain a string value for invoking a schedule management application. The URL may further contain a value indicating the reply deadline.

When the task logging UI element is selected, at operation 805, the electronic device 300 records the reply deadline for the email message as a schedule item (task or event) managed by the schedule management application. Here, the schedule management application may be an application identical to the email application displaying the task logging UI element.

In an example embodiment, to record the reply deadline as a schedule item, the electronic device 300 may display a schedule management window containing a reply deadline field.

The schedule management window may include at least one of a title item for reply message indication, a deadline item for setting the reply deadline, a reminder item for setting a reminder time for the reply deadline, a memo item for writing a memo on the email reply, and a priority item for assigning a priority to the email reply.

When the reminder time arrives, the electronic device 300 may display a reminder window containing an email composition UI element having a URL for making a reply. When the email composition UI element is selected, the electronic device 300 may display an email writing window for composing a reply message.

In various example embodiments, the electronic device 300 may parse the reply request flag contained in a received email message. When the reply request flag is set to a specific value, the electronic device 300 may display a popup window containing a task logging UI element.

While the present disclosure has been illustrated and described with reference to various example embodiments thereof, it will be understood by those skilled in the art that various changes in form and details may be made therein without departing from the spirit and scope of the present disclosure as defined by the appended claims and their equivalents.

What is claimed is:

1. A method for email management in an electronic device, the method comprising:
receiving an email message comprising a message body and a reply deadline;
displaying a task logging user interface (UI) element including a uniform resource locator (URL) for recording the reply deadline as a task; and
recording, when the task logging UI element is selected, the reply deadline for the email message as a task managed by a schedule management application.

2. The method of claim 1, wherein recording the reply deadline as a task comprises displaying a schedule management window comprising a field to present the reply deadline.

3. The method of claim 2, wherein the schedule management window comprises at least one of: a deadline item to set a reply deadline for the email message, a reminder item to set a reminder time for the reply deadline, a title item for the email reply, a memo item to write a memo on the email reply, and a priority item to assign a priority to the email reply.

4. The method of claim 3, further comprising:
displaying, at the reminder time, a reminder window including an email composition UI element including a URL for making a reply; and
displaying, when the email composition UI element is selected, an email writing window for composing a reply message corresponding to the email message.

5. The method of claim 1, further comprising:
displaying an email composition UI element including a URL for making a reply to the email message; and
displaying, when the email composition UI element is selected, an email writing window for composing a reply message corresponding to the email message.

6. The method of claim 1, further comprising:
parsing a reply request flag included in the email message; and
displaying, when the reply request flag is set to a given value, a popup window including the task logging UI element.

7. The method of claim 1, wherein the URL comprises a string value for invoking the schedule management application.

8. The method of claim 1, wherein the URL includes a value indicating the reply deadline.

9. The method of claim 1, wherein the task logging UI element further comprises reply-requesting words.

10. The method of claim 1, wherein the schedule management application is substantially identical to the email application displaying the task logging UI element.

11. An electronic device comprising:
a display configured to output visual information;
a communication unit comprising communication circuitry configured to communicate with an external electronic device; and
a processor electrically connected with the display and communication unit,
wherein the processor is configured to control the communication circuitry of the communication unit to receive an email message comprising a message body and a reply deadline from the external electronic device, to control the display to display a task logging UI element including a URL for recording the reply deadline as a task, and to record, when the task logging UI element is selected, the reply deadline for the email message as a task managed by a schedule management application.

12. The electronic device of claim 11, wherein, to record the reply deadline as a task, the processor is configured to control the display to display a schedule management window including a field to present the reply deadline.

13. The electronic device of claim 12, wherein the schedule management window comprises at least one of: a deadline item to set a reply deadline for the email message, a reminder item to set a reminder time for the reply deadline, a title item for the email reply, a memo item to write a memo on the email reply, and a priority item to assign a priority to the email reply.

14. The electronic device of claim 13, wherein, the processor is configured to control the display to display a reminder window at the reminder time, the reminder window including an email composition UI element including a URL for making a reply, and wherein, when the email composition UI element is selected, the processor is configured to control the display to display an email writing window for composing a reply message corresponding to the email message.

15. The electronic device of claim 11, wherein the processor is configured to control the display to further display an email composition UI element including a URL for making a reply to the email message, and wherein, when the email composition UI element is selected, the processor is configured to control the display to display an email writing window for composing a reply message corresponding to the email message.

16. The electronic device of claim 11, wherein the processor is configured to parse a reply request flag included in the email message, and to control, when the reply request flag is set to a given value, the display to display a popup window including the task logging UI element.

17. The electronic device of claim 11, wherein the URL includes a string value for invoking the schedule management application.

18. The electronic device of claim 11, wherein the URL includes a value indicating the reply deadline.

19. The electronic device of claim 11, wherein the schedule management application is substantially identical to the email application displaying the task logging UI element.

20. A non-transitory computer-readable storage medium storing a scheduling program that, when executed by a processor, causes an electronic device to: receive an email message comprising a message body and a reply deadline; display a task logging UI element including a URL for recording the reply deadline as a task; and record, when the task logging UI element is selected, the reply deadline for the email message as a task managed by a schedule management application.
